(19) United States
(12) Patent Application Publication
(10) Pub. No.: US 2024/0173812 A1
(43) Pub. Date: May 30, 2024

(54) TOOL MACHINING LOAD MONITORING METHOD

(71) Applicant: INDUSTRIAL TECHNOLOGY RESEARCH INSTITUTE, Hsinchu (TW)

(72) Inventor: MING-CHUN HO, Taichung (TW)

(21) Appl. No.: 18/098,173

(22) Filed: Jan. 18, 2023

(30) Foreign Application Priority Data
Nov. 30, 2022 (TW) 111145855

(51) Int. Cl. B23Q 17/09

(52) U.S. Cl. CPC B23Q 17/0961; B23Q 17/0995

(57) ABSTRACT

A tool machining load monitoring method includes a step of collecting a load information of a driver of the machine tool in different time periods while a tool is cutting; according to the load information, a step of finding and calculating a threshold valve corresponding to a constant speed period during cutting, and a step of, according to the threshold value of the constant speed period, determining whether or not a treatment upon the tool is necessary.

### CROSS REFERENCE TO RELATED APPLICATION

This application claims the benefits of Taiwan application Serial No. 111145855, filed on Nov. 30, 2022, the disclosures of which are incorporated by references herein in its entirety.

### TECHNICAL FIELD

The present disclosure relates in general to a tool machining load monitoring method.

### BACKGROUND

In machining equipment, loads upon a spindle motor and a feed motor would vary all the time. Reasons for load changes may include tool wear, bearing damage or looseness in a spindle box, insufficient cooling or lubrication. However, no matter what the real reason is to cause the equipment to be overloaded, an unexpected but inevitable consequence of such loading is led to a unacceptable damage such as tool breakage.

Nevertheless, in the art, a machine tool usually includes a controller, a driver and a mechanism. The driver can capture a motor current and convert it into load information. In particular, the tool wear during cutting may increase the load on the servo shaft and/or spindle. During machining and cutting, different cutting speeds, depths and machine conditions may affect axial load values. Therefore, how to monitor a processing tool to avoid tool breakage or any damage will be an issue urgent to be solved in the art.

### SUMMARY

An object of the present disclosure is to provide a tool machining load monitoring method that can establish monitoring load functions during axial cutting, remind a user of the degree of tool wear, reduce collisions caused by tool breakage, avoid possible reduced productivity, and increase the robustness of tool monitoring.

In one embodiment of this disclosure, a tool machining load monitoring method includes the steps of: collecting a load information of a driver of the machine tool in different time periods while a tool is cutting; according to the load information, finding and calculating a threshold valve corresponding to a constant speed period during cutting; and, according to the threshold value of the constant speed period, determining whether or not a treatment upon the tool is necessary.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 is a schematic view of an embodiment of a setup to perform the tool machining load monitoring method in accordance with this disclosure;

FIG. 2 is a schematic flowchart of an embodiment of the tool machining load monitoring method in accordance with this disclosure;

FIG. 3A shows schematically an exemplary example of the learning process in accordance with this disclosure;

FIG. 3B shows schematically another exemplary example of the learning process in accordance with this disclosure; and

FIG. 3C shows schematically an exemplary example of the monitoring process in accordance with this disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

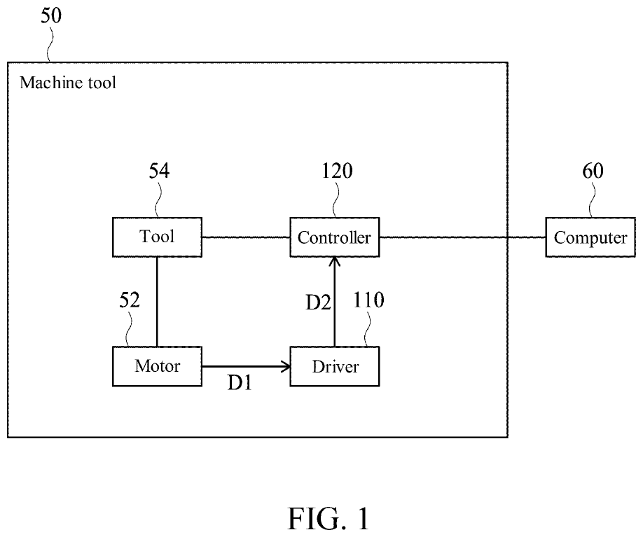

FIG. 1 is a schematic view of an embodiment of a setup to perform the tool machining load monitoring method in accordance with this disclosure. As shown, the tool machining load monitoring method can be implemented as an electronic circuit installed in a controller 120 of a machine tool 50 to be operated independently, or as a program installed in a computer 60 to be performed by a processor (not shown in the figure) for being cooperated with the controller 120. In this program, instructions can be controlled by the controller 120 to operate the driver 110 and the motor 52 to further control the tool 54 to execute corresponding processing steps. In addition, each row of the program is called as a block. The machine tool 50 includes a motor 52 and a tool 54, in which the motor 52 can drive the tool 54 to perform processing. The motor 52 is controlled by the driver 110 and the controller 120. The controller 120 follows program instructions of a block to consequently perform the preset processing. The motor 52 is connected with the driver 110, and the driver 110 is configured for capturing a motor current D1, and converting the current D1 into a corresponding load information D2. The driver 110, connected with the controller 120, transmits the load information D2 to the controller 120, and thus the computer 60 can receive relative information from the controller 120.

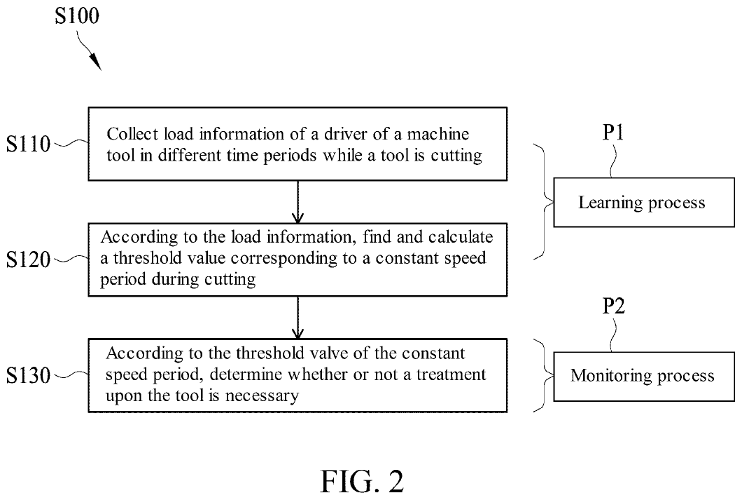

FIG. 2 is a schematic flowchart of an embodiment of the tool machining load monitoring method in accordance with this disclosure. Referring to FIG. 1 and FIG. 2, the tool machining load monitoring method S100, operated by the controller 120 to work independently or to cooperate the computer 60, includes Step S110 to Step S130 as follows. It shall be explained that, in this embodiment, Step S110 to Step S120 are used to demonstrate a learning process P1, while Step S130 is to demonstrate a monitoring process P2 according to results obtained from the learning process P1 (i.e., Step S110 and Step S120).

In performing Step S110, while the tool 54 is cutting, load information D2 of the driver 110 in different (cutting) time periods would be collected. It is noted that, in these time periods, the tool 54 may have contacted, or yet to contact, a workpiece.

Step S110 includes the following Steps: determine whether or not to begin a processing? If negative, then the processing would be ended. If positive, then the processing is begun. Then, determine whether or not it is a new block of instructions? If negative, continue to determine whether or not the instruction is a cutting command. If a new block of instructions is met, then initialize an upper bound, a lower bound, an accumulated time and so on. The upper bound and the lower bound are obtained from the load information D2, while the accumulated time is the accumulated time for the cutting. Then, determine whether or not a cutting command is met. In this embodiment, the controller 120 can read the block instructions to determine if a cutting command has met. If negative, then go back to the step of determining whether or not to begin the processing. If the cutting command is met, then keep updating the accumulated time for the processing. Then, determine whether or not the processing is within a constant speed period. Generally speaking, within the constant speed period, the tool 54 is contacted at the workpiece.

In one embodiment, determine whether or not the cutting of the processing is within the constant speed period. For example, determine whether or not the accumulated time is greater than the time for the accelerating/decelerating periods. Namely, if the accumulated time of the processing is greater than the accelerating period or the decelerating period, then it can be determined that the accelerating period or the decelerating period has passed, and thus the state of being within the constant speed period can be determined. In addition, according to the motion status or the feedback speed, it can be determined whether or not an accelerating signal, an equal-speed signal or a decelerating signal has been received. Generally, if the processing is within the accelerating period or the decelerating period, the tool 54 doesn't contact the workpiece.

In one embodiment, determine whether or not the cutting of the processing is within the constant speed period. For example, if the load information D2 received by the controller 120 is an equal-speed signal, then the cutting of the processing within the constant speed period can be determined.

In one embodiment, determine whether or not the cutting of the processing is within the constant speed period. For example, in order to determine whether or not the acceleration value of the load information D2 is less than a minimum setting value. According to a speed value or a position value, the acceleration value of the load information D2 can be calculated. In this embodiment, the controller 120 is built in with the preset acceleration value. If the acceleration value of the load information D2 is less than the preset acceleration value, then this period of the processing is judged to be the constant speed period.

If the cutting of the processing is not within the constant speed period, then it shall be within a non-constant speed period (i.e., an accelerating period or a decelerating period), then go back to the step of determining whether or not to begin the processing. If the cutting of the processing is within the constant speed period, then read the load information D2, where the driver 110 is used to capture the motor current D1 and further convert the motor current D1 into corresponding load information D2. Then, in performing Step S120, according to the load information D2, the threshold valve corresponding to the cutting within the corresponding to the constant speed period can be found and thus calculated, in which the threshold value includes an upper threshold value and a lower threshold value.

If it is determined that the cutting of the processing is within the constant speed period, then firstly axial load signals would be read. Then, the axial load signals can be processed through the RMS (Root mean square) technique to obtain the load information D2. In the RMS calculation, the instant axial load signal and the preceding axial load signal are involved. In this embodiment, the load signal can be a load percentage or a current value of the motor.

Then, determine whether or not the load information D2 is greater than an upper bound. If the load information is greater than the upper bound, then the upper bound and an upper threshold value would be updated. The upper threshold value is a product of the updated upper bound and a first scale value. Then, determination upon whether or not the load information is less than a lower bound would be followed.

If the determination is negative (i.e., the load information is not greater than the upper bound), or after the upper threshold value is updated, then determine whether or not the load information D2 is less than a lower bound. If negative, then go back to the step of determining whether or not to begin the processing. If the load information D2 is less than the lower bound, then the lower bound and a lower threshold value would be updated. The upper threshold value is a product of the updated lower bound and a second scale value.

It shall be explained that the first scale value, the second scale value and the like scale value can be adjusted according to the status of the machine tool, such that the processing stability can be continuously monitored.

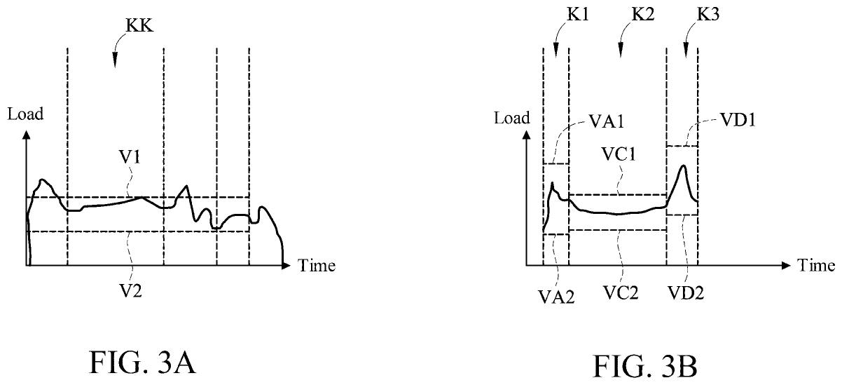

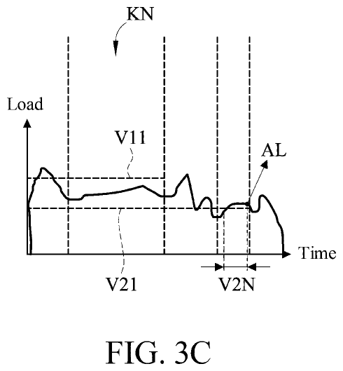

Through the learning process P1 prior to the monitoring process P2, the threshold value of the constant speed period can be obtained. As shown in FIG. 3A, in the constant speed period KK, the upper threshold value V1 and the lower threshold value V2 can be obtained.

As described above, in this disclosure, the load information within the constant speed period can be obtained, such that, while the load varies due to different motion situations such as acceleration or deceleration of the motor 52, the accuracy in judging the corresponding threshold value can be upheld.

However, this disclosure is not limited thereto. In some other embodiments, as shown in FIG. 3B, according to the accelerating period K1, the constant speed period K2 and the decelerating period V3, an accelerating-period upper threshold value VA1 and an accelerating-period lower threshold value VA2, a constant-speed-period upper threshold value VC1 and a constant-speed-period lower threshold value VC2, a decelerating-period upper threshold value VD1 and a decelerating-period lower threshold value VD2 can be respectively obtained. Further, a single time period can be divided into an accelerating period K1, a constant speed period K2 and a decelerating period V3. Through the speed value or the position value to calculate the acceleration value, and when the constant speed period is determined through judging the acceleration value, the accelerating period K1, the constant speed period K2 and the decelerating period V3 would be defined individually with the upper and lower percentages, and the corresponding upper and lower threshold values. Thus, according to different monitoring conditions, the single period can be divided to provide 6 different threshold values corresponding to the accelerating period K1, the constant speed period K2 and the decelerating period V3.

Referring back to FIG. 2, in performing Step S130, according to the threshold value of the constant speed period, determine whether or not a treatment upon the tool 54 shall be executed, and thus the tool 54 can be examined as well. According to different threshold values corresponding to different cutting periods with respect to various motion conditions, appropriate treatments shall be chosen and applied.

In the monitoring process P2, a determination process of an embodiment includes the steps of: determining whether or not to begin the processing. If negative, then end the processing. If positive, then it is further determined whether or not a new block of the processing shall begin. If negative, then further determine whether or not new cutting commands have met. If a new block is met, then initiate the upper bound, the lower bound, the accumulated time and the maintain time. In this embodiment, the maintain time can be set through parameter setting, and each set of determined threshold values would be provided with a set of maintain times, or all the determined threshold values are assigned with the same maintain time.

Then, determine whether or not a cutting command is met. If negative, then go back to the step of determining whether or not to begin the processing. If it is determined that the cutting command is met, then keep updating the accumulated time of the instant cutting condition. Then, determine whether or not in a constant speed period of the processing. If negative, then go back to the step of determining whether or not to begin the processing. If it is determined to be within the constant speed period during the cutting, then the load information can be captured. Thereupon, while the load varies due to different motion situations such as acceleration or deceleration of the motor 52, the accuracy in judging the corresponding threshold value can be upheld. As shown in FIG. 3C, in monitoring the constant speed period KN, it is determined whether or not the upper threshold value VII or the lower threshold value V2I has been exceeded.

If it is determined that the cutting of the processing is not within the constant speed period, then go back to the step of determining whether or not to begin the processing. If it is determined that the cutting of the processing is within the constant speed period, then firstly axial load signals would be read. Then, the axial load signals can be processed through the RMS (Root mean square) technique to obtain the load information. Then, determine whether or not the load information is greater than an upper threshold value. If negative, then a counter of the maintain time would be initiated. Otherwise, if it is determined that the load information is greater than an upper threshold value, then a proper treatment would be executed. Since the load information is beyond the upper threshold value, it may imply that, due to the increase of the load information, the tool 54 might be blunt already, and thus it is suggested that the blunt tool 54 shall be replaced. In addition, the counting of the maintain time is continuous. Then, it is determined whether or not the counter provides a number greater than the maintain time. If negative, then the counter of the maintain time would be initiated. Otherwise, if the accumulated time provided by the counter is beyond the maintain time, as the time period V2N shown in FIG. 3C, then it implies that a corresponding alert AL is necessary to warn that the machine tool 50 might be abnormal. Upon the processing to be kept continuously, any further abnormality would justify an immediate replacement of the tool 54.

To sum up, the tool machining load monitoring method provided in this disclosure establishes the load monitoring function during axial cutting, reminds the user of the tool wear degree, reduces possible collision caused by tool breakage, avoids the problem of reduced productivity, and increases the robustness of the tool monitoring status.

Furthermore, this disclosure captures the load information of the constant speed period, so as to avoid the interference from the load changes caused by different motion states, such as the acceleration and deceleration of the motor, and thus the accuracy of determining the subsequent threshold value can be upheld.

With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

What is claimed is:

1. A tool machining load monitoring method, implemented in a computer to cooperate with a controller of a machine tool to perform the following steps of:
collecting a load information of a driver of the machine tool in different time periods while a tool is cutting;
according to the load information, finding and calculating a threshold valve corresponding to a constant speed period during cutting; and
according to the threshold value of the constant speed period, determining whether or not a treatment upon the tool is necessary.

2. The tool machining load monitoring method of claim 1, wherein the step of collecting the load information of the driver of the machine tool in different time periods while the tool is cutting includes the steps of:
determining whether or not the cutting is in the constant speed period; and
if positive, then reading the load information.

3. The tool machining load monitoring method of claim 2, wherein the step of determining whether or not the cutting is in the constant speed period includes the steps of:
determining whether or not an accumulated time during cutting is greater than a time of an accelerating period or a decelerating period; and
if negative, then the constant speed period is determined.

4. The tool machining load monitoring method of claim 2, wherein, in the step of determining whether or not the cutting is in the constant speed period, the load information is an equal-speed signal.

5. The tool machining load monitoring method of claim 2, wherein the step of determining whether or not the cutting is in the constant speed period includes the steps of:
determining whether or not an acceleration value of the load information is less than a preset acceleration value; and
if positive, a time period having the acceleration value of the load information is determined to be the constant speed period.

6. The tool machining load monitoring method of claim 5, wherein the step of determining whether or not the acceleration value of the load information is less than the preset acceleration value includes a step of: calculation the acceleration value according to a speed value or a position value.

7. The tool machining load monitoring method of claim 1, wherein the step of, according to the load information, finding and calculating the threshold valve corresponding to a constant speed period during cutting includes the steps of:
determining whether or not the load information is greater than an upper bound; and
if positive, the updating the upper bound and an upper threshold value, wherein the threshold value includes the upper threshold value and a lower threshold value, and the upper threshold value is a product of the updated upper bound and a first scale value.

8. The tool machining load monitoring method of claim 7, if negative or after the upper threshold value is updated, including the steps of:
determining whether or not the load information is less than a lower bound; and
if positive, then updating the lower bound and a lower threshold value, wherein the lower threshold value is a product of the updated lower bound and a second scale value.

9. The tool machining load monitoring method of claim 2, wherein the step of determining whether or not the cutting is in the constant speed period includes the step of: with respect to an accelerating period, the constant speed period, and an decelerating period, obtaining an accelerating-period upper threshold value and an accelerating-period lower threshold value, a constant-speed-period upper threshold value and a constant-speed-period lower threshold value, and a decelerating-period upper threshold value and a decelerating-period lower threshold value, respectively.
